(19) United States
(12) Patent Application Publication
(10) Pub. No.: US 2023/0122889 A1
(43) Pub. Date: Apr. 20, 2023

(54) DETECTION OF AIRCRAFT ICING CONDITIONS AND DETERMINATION OF LIQUID CLOUD DROPLET SIZE

(71) Applicant: Rosemount Aerospace Inc., Burnsville, MN (US)

(72) Inventors: Kaare Josef Anderson, Farmington, MN (US); Mark Ray, Burnsville, MN (US); Kent Allan Ramthun, Shakopee, MN (US); Mark Sherwood Miller, Lakeville, MN (US)

(21) Appl. No.: 17/503,728

(22) Filed: Oct. 18, 2021

(51) Int. Cl. B64D 15/20; G01N 15/02

(52) U.S. Cl. CPC B64D 15/20; G01N 15/0211; G01N 2015/0222; G01N 2015/0026

(57) ABSTRACT

A method of operating an optical icing conditions sensor includes transmitting, with a transmitter, a light beam and thereby illuminating an illumination volume. A receiver array receives light over a range of receiving angles. The receiver array is configured to receive light having the wavelength over a receiver array field of view which overlaps with the illumination volume. A controller measures an intensity of light received by the receiver array. The controller determines that a cloud is present if the intensity is greater than a threshold value. The controller calculates scattering profile data of the light received by the receiver array if a cloud is determined to be present, which includes an angle of a scattering intensity peak within the range of receiving angles and a breadth of the scattering intensity peak. The controller estimates a representative droplet size within the cloud using the scattering profile data.

### BACKGROUND

The present disclosure relates generally to optical sensors, and in particular to an optical icing conditions sensor for an aircraft.

It is desirable to enable an optical sensor to both detect potential icing conditions and determine a representative droplet size within clouds containing water droplets. Different droplet sizes can require particular safety processes to be enabled. However, some droplet size estimation methods are performed using short pulse width lasers, and these methods require high-speed, sensitive electronics to detect the cloud reflection signals generated by the short pulse width lasers.

### SUMMARY

According to one aspect of the present invention, a method of operating an optical icing conditions sensor for an aircraft includes transmitting, with a transmitter, a light beam having a wavelength through an optical window of the aircraft at a transmitting angle. The light beam illuminates an illumination volume. The transmitter is oriented along a transmitter path which extends along the transmitting angle. A receiver array receives light over a range of receiving angles relative to the transmitter path. The receiver array is configured to receive light having the wavelength over a receiver array field of view which overlaps with the illumination volume at a predetermined distance. A controller measures an intensity of light received by the receiver array. The controller compares the intensity to a threshold value. The controller determines that a cloud is present if the intensity is greater than the threshold value. The controller calculates scattering profile data of the light received by the receiver array if a cloud is determined to be present. The scattering profile data includes an angle of a scattering intensity peak within the range of receiving angles and a breadth of the scattering intensity peak. The controller estimates a representative droplet size within the cloud using the scattering profile data.

According to another aspect of the present invention, an optical icing conditions sensor for an aircraft includes a transmitter, a receiver array, and a controller. The transmitter is oriented along a transmitter path and is configured to transmit a light beam having a wavelength through an optical window at a transmitting angle relative to the optical window. The receiver array is configured to receive light having the wavelength over a range of receiving angles relative to the transmitter path. The controller is configured to measure an intensity of light received by the receiver array over the range of receiving angles. The controller is further configured to compare the intensity to a threshold value. The controller is further configured to determine that a cloud is present if the intensity is greater than the threshold value. The controller is further configured to calculate scattering profile data of the light received by the receiver array if a cloud is determined to be present. The scattering profile data includes an angle of a scattering intensity peak within the range of receiving angles and a breadth of the scattering intensity peak. The controller is further configured to estimate a representative droplet size within the cloud using the scattering profile data.

According to yet another aspect of the present invention, a controller for an optical icing conditions sensor of an aircraft includes at least one processor, at least one memory unit, and at least one communication unit. The controller is configured to measure an intensity of light received by a receiver array over a range of receiving angles. The controller is further configured to compare the intensity to a threshold value. The controller is further configured to determine that a cloud is present if the intensity is greater than the threshold value. The controller is further configured to calculate scattering profile data of the light received by the receiver array if a cloud is determined to be present. The scattering profile data includes an angle of a scattering intensity peak within the range of receiving angles and a breadth of the scattering intensity peak. The controller is further configured to estimate a representative droplet size within the cloud using the scattering profile data.

### BRIEF DESCRIPTION OF THE DRAWINGS

The subject matter, which is regarded as the disclosure, is particularly pointed out and distinctly claimed in the claims at the conclusion of the specification. The following descriptions of the drawings should not be considered limiting in any way.

FIG. 1 is a schematic view of an optical icing conditions sensor.

FIG. 2 is a schematic depiction of a controller for the optical icing conditions sensor of FIG. 1.

FIG. 3 is a polar plot of the scattering intensity of water droplets.

FIG. 4A is a graph of water droplet scattering intensity for a water droplet size distribution having median volumetric diameter of 15 micrometers over a range of scattering angles.

FIG. 4B is a graph of water droplet scattering intensity for a water droplet size distribution having median volumetric diameter of 50 micrometers over a range of scattering angles.

FIG. 4C is a graph of water droplet scattering intensity for a water droplet size distribution having median volumetric diameter of 200 micrometers over a range of scattering angles.

FIG. 4D is a graph of water droplet scattering intensity for a water droplet size distribution having median volumetric diameter of 500 micrometers over a range of scattering angles.

FIG. 5 depicts a method of operating an optical icing conditions sensor.

### DETAILED DESCRIPTION

An optical icing conditions sensor detects clouds and determines a median volumetric diameter of water droplets in the cloud. The optical icing conditions sensor contains a receiver array which can measure received light intensity over a range of angles to determine at which angle a scattering intensity peak occurs. Liquid water droplets will exhibit different scattering intensity characteristics (in particular, a different angle at which a scattering intensity peak occurs and a different breadth of the scattering intensity peak) depending on their size.

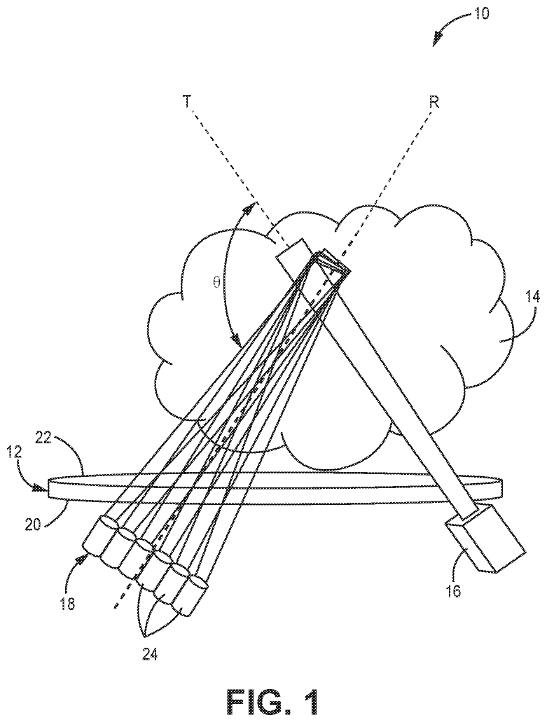

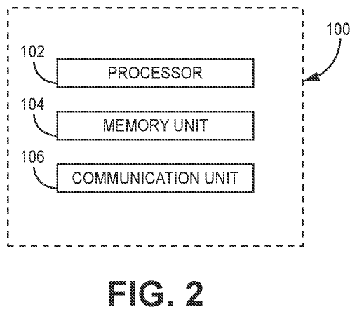

FIG. 1 depicts optical icing conditions sensor (OICS) 10, optical window 12, and cloud 14. OICS 10 includes transmitter 16 and receiver array 18. OICS 10 can additionally include a controller, such as controller 100 (shown in FIG. 2). Optical window 12 can have inner surface 20 and outer surface 22. Receiver array 18 includes receivers 24.

Optical window 12 can be an optically transparent window which is located on a surface of an aircraft such that outer surface 22 contacts the air surrounding the aircraft. OICS 10 can be located adjacent to inner surface 20 of optical window 12 such that OICS 10 is within the aircraft. Transmitter 16 can be an optical transmitter. Transmitter 16 can be configured to transmit a light beam at a wavelength, which can be in the range of visible or infrared light depending upon the selected transmitter 16 and/or receiver array 18. In some examples, the wavelength can be between 400 and 500 nanometers, and in particular can be 445 nanometers. In other examples, the wavelength can be between 800 and 1000 nanometers, and in particular can be 920 nanometers. In some examples, OICS 10 can include multiple transmitters 16, and each transmitter 16 can be configured to transmit light at a particular wavelength. Receiver array 18 can include at least one optical receiver 24. In some examples, receiver array 18 can include a plurality of receivers 24. Receiver array 18 can be configured to receive light over a range of angles. Receiver array 18 can be configured to receive light at the wavelength. The wavelength can be selected to have a difference in scattering intensities for different droplet sizes. Each of the plurality of receivers 24 has a receiver field of view. The receiver fields of view of the plurality of receivers 24 define the receiver array field of view such that the receiver fields of view cover the range of receiving angles.

Transmitter 16 is oriented along transmitter path T, such that transmitter 16 emits a light beam at the wavelength along transmitter path T during operation. Transmitter 16 emits the light beam at a transmitting angle defined by transmitter path T and optical window 12.

Receiver array 18 is oriented along receiver array path R, such that receiver array 18 receives light at the wavelength along receiver array path R during operation. Receiver array 18 receives light at the wavelength at a plurality of receiving angles defined by receiver array path R and optical window 12. Each receiving angle can correspond to a receiver 24 within receiver array 18.

During operation, the light beam emitted by transmitter 16 illuminates an illumination volume in cloud 14. Each receiver 24 has a receiver field of view. Receiver array 18 has a receiver array field of view, which is made up of the receiver fields of view for all of the receivers 24 within receiver array 18. These receiver fields of view are centered on receiver array path R such that the receiver array field of view extends above and below the angle at which receiver array path R is oriented. The receiver array field of view covers a range of angles over which receiver array 18 can receive light. Receiver array 18 is configured to receive light having the first wavelength over the receiver array field of view during operation. OICS 10 is configured such that the receiver array field of view overlaps with the illumination volume at a predetermined distance. The predetermined distance can be defined as the distance from outer surface 22 of optical window 12 at which the overlap occurs. These overlaps allow receiver array 18 to receive light from transmitter 16 following reflection by water in cloud 14.

Transmitter path T and receiver array path R intersect at a distance from outer surface 22 of optical window 12. The intersection of transmitter path T and receiver array path R forms reflecting angle θ. In the depicted embodiment, reflecting angle θ is approximately 136 degrees. Reflecting angle θ can be selected such that light emitted along transmitter path T can be reflected by water droplets in cloud 14 and subsequently travel along receiver array path R to receiver array 18. As described below, reflecting angle θ can be selected such that it is approximately a rainbow angle. During operation, reflecting angle θ can be defined as the angle between the light beam transmitted at the transmitting angle and light received by receiver array 18 at the receiving angle. In the depicted example, reflecting angle θ is 136 degrees, and the receiver array field of view extends from 126 degrees to 146 degrees. Reflecting angle θ can have a tolerance of approximately ±1 degree.

As described below in more detail, transmitter 16 and receiver array 18 allow OICS 10 to estimate the median volumetric diameter (MVD) of water droplets present in clouds. The MVD is the droplet diameter below which, and above which, half of the cumulative water content in a cloud is contained. For example, a cloud having an MVD of 15 micrometers signifies that half of the water content in the cloud is contained in droplets which have a diameter of less than 15 micrometers, and the other half of the cloud's water content is contained in droplets which have a diameter greater than 15 micrometers. Liquid water droplets in clouds exhibit scattering behavior which includes a peak at a particular “rainbow” angle, and the scattering behavior varies based on the MVD of the water droplets. An optical sensor (such as OICS 10) can be configured to discriminate between these behaviors to determine the MVD of the water droplets within the detected cloud.

FIG. 2 is a schematic depiction of controller 100. Controller 100 can include processor 102, memory unit 104, and communication unit 106. In some embodiments, controller 100 can include multiple processors 102, memory units 104, and communication units 106. Controller 100 can additionally include more components, such as an input device, an output device, and/or a power source.

Processor 102 can be configured to implement functionality and/or process instructions for execution within controller 100. For example, processor 102 can be capable of processing instructions stored in memory unit 104. Examples of processor 102 can include any one or more of a microprocessor, a controller, a digital signal processor (DSP), an application specific integrated circuit (ASIC), a field-programmable gate array (FPGA), or other equivalent discrete or integrated logic circuitry. Instructions executed by processor 102 can cause controller 100 to perform actions, such as receiving and measuring input data from receivers within OICS 10, comparing these measurements to threshold values, and using these measurement comparisons to determine if a cloud is present.

Controller 100 can also include memory capable of storage, such as memory unit 104. Memory unit 104 can be configured to store information (and/or instructions which may be executable by processor 102) within controller 100 during operation. Memory unit 104, in some examples, is described as a computer-readable storage medium. In some examples, a computer-readable storage medium can include a non-transitory medium. The term “nontransitory” can indicate that the storage medium is not embodied in a carrier wave or a propagated signal. In certain examples, a non-transitory storage medium can store data that can, over time, change (e.g., in RAM or cache). In some examples, memory unit 104 is a temporary memory, meaning that a primary purpose of memory unit 104 is not long-term storage. Memory unit 104, in some examples, is described as volatile memory, meaning that memory unit 104 does not maintain stored contents when power to controller 100 is turned off. Examples of volatile memories can include random access memories (RAM), dynamic random access memories (DRAM), static random access memories (SRAM), and other forms of volatile memories. In some examples, memory unit 104 is used to store program instructions for execution by processor 102.

Memory unit 104 can be configured to store larger amounts of information than volatile memory. Memory unit 104 can further be configured for long-term storage of information. In some examples, memory unit 104 includes non-volatile storage elements. Examples of such nonvolatile storage elements can include magnetic hard discs, optical discs, flash memories, or forms of electrically programmable memories (EPROM) or electrically erasable and programmable (EEPROM) memories.

Controller 100 can also include communication unit 106. Controller 100 can utilize communication unit 106 to communicate with devices via one or more networks, such as one or more wireless or wired networks or both. Communication unit 106 can be a network interface card, such as an Ethernet card, an optical transceiver, a radio frequency transceiver, or any other type of device that can send and receive information. For example, communication unit 106 can be a radio frequency transmitter dedicated to Bluetooth or WiFi bands or commercial networks such as GSM, UMTS, 3G, 4G, 5G, and others. Alternately, communication unit 106 can be a Universal Serial Bus (USB).

Controller 100 can include an input device, such as a presence-sensitive and/or touch-sensitive display, or other type of device configured to receive input from a user. Controller 100 can include an output device, such as a display device, a speaker, a liquid crystal display (LCD), a light emitting diode (LED) display, an organic light emitting diode (OLED) display, discrete switched outputs, or other type of device for outputting information in a form understandable to users or machines.

Controller 100 can be configured to receive and measure input data from one or more receivers within OICS 10. For example, controller 100 can be configured to measure an intensity of light received by receiver array 18. Controller 100 can be further configured to compare measurements to one or more threshold values. For example, controller 100 can be configured to compare the intensity to a threshold value. Controller 100 can be further configured to use measurement comparisons to determine if a cloud is present. For example, controller 100 can be configured to determine that a cloud is present if the intensity exceeds the threshold value.

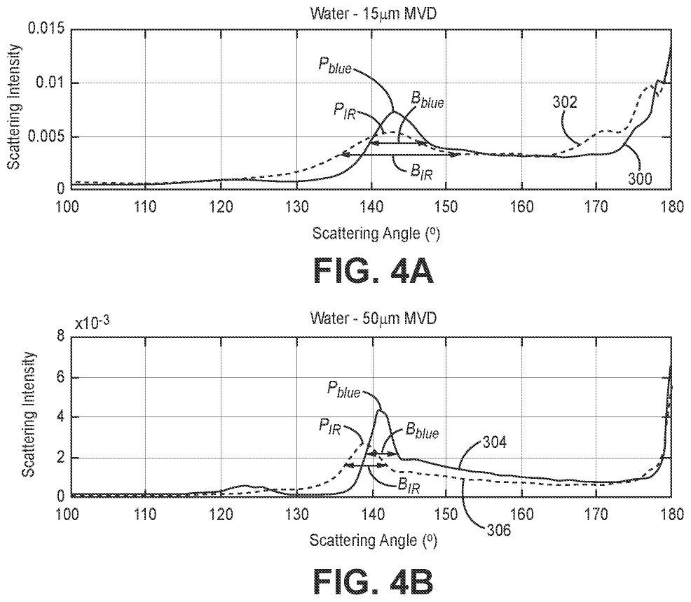

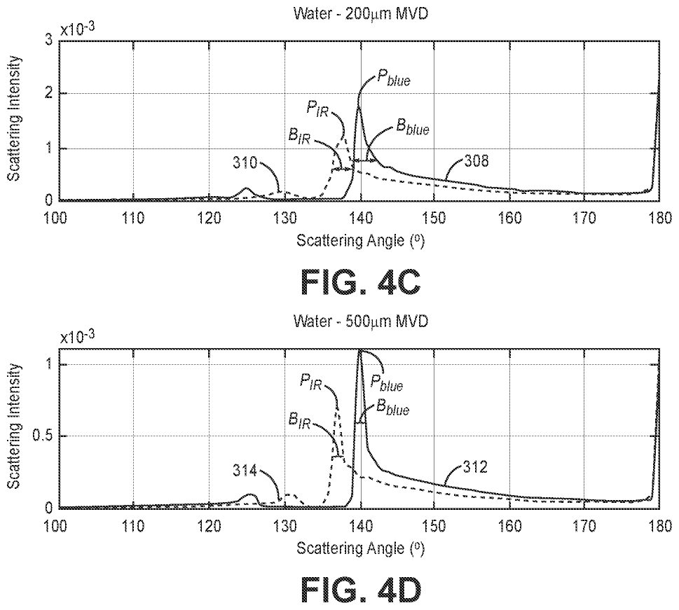

If controller 100 determines a cloud to be present, controller 100 can be configured to calculate scattering profile data of water droplets within the cloud to determine an MVD of the water droplets. This scattering profile data can include the angle at which a scattering intensity peak occurs and the breadth of the scattering intensity peak. The breadth of scattering intensity peaks (such as those shown in FIGS. 4A-4D) can be defined as the full width at half maximum (in this case, half the value of the maximum scattering intensity) after subtraction of the background signal from ambient light sources. The background signal can be defined as an interpolation of the measured light intensity from points which are ±15 degrees from the scattering intensity peak. Controller 100 can be further configured to use this scattering profile data to estimate the MVD using reference data, such as a look-up table. Controller 100 can be configured to communicate the droplet size to another component of the aircraft, such as a display screen or a de-icing system. Controller 100 allows OICS 10 to determine a representative droplet size of water droplet, as defined by the MVD, within a cloud (such as cloud 14 in FIG. 1) detected in the vicinity of the aircraft.

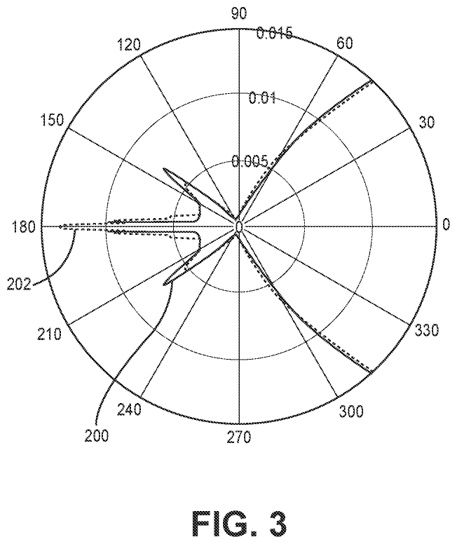

FIG. 3 is a polar plot of the scattering intensity of water droplets. In FIG. 3, the angular coordinates denote the angle of incident light (the angle at which light strikes a water droplet), and the radial coordinates denote the scattering intensity for each angle of incident light. Blue trend line 200 depicts scattering intensities at 445 nanometers, and infrared trend line 202 depicts scattering intensities at 920 nanometers. The scattering data displayed in FIG. 3 corresponds to water droplets having MVD of 15 micrometers. While the scattering data for water droplets having MVD of 15 micrometers is shown here, water droplets having a different size will exhibit similar behavior (showing a scattering intensity peak).

When light illuminates liquid water droplets, such as those that make up a cloud, the water droplets have a scattering intensity which is dependent on the angle at which light illuminates the water droplets. For a range of angles, the water droplets have a corresponding range of scattering intensities. This range of scattering intensities will peak at approximately a rainbow angle. The rainbow angle has a tolerance of approximately ±1 degree. The rainbow angle can vary based on the wavelength of the light which is interacting with the water droplets. The range of scattering intensities will also vary based on the size of the water droplets, and a particular droplet size will correspond to a particular maximum scattering intensity/rainbow angle, as well as to a particular breadth of the scattering intensity peak. This difference in scattering behaviors allows for an OICS, such as OICS 10, to estimate the MVD of water droplets within a cloud.

FIG. 4A is a graph of water droplet scattering intensity for a water droplet size distribution having MVD of 15 micrometers over a range of scattering angles. FIG. 4B is a graph of water droplet scattering intensity for a water droplet size distribution having MVD of 50 micrometers over a range of scattering angles. FIG. 4C is a graph of water droplet scattering intensity for a water droplet size distribution having MVD of 200 micrometers over a range of scattering angles. FIG. 4D is a graph of water droplet scattering intensity for a water droplet size distribution having MVD of 500 micrometers over a range of scattering angles. FIGS. 4A-4D will be discussed in turn below.

In FIG. 4A, blue trend line 300 depicts scattering intensities at 445 nm, and infrared trend line 302 depicts scattering intensities at 920 nm. As described above in reference to FIG. 3, water droplets have a varying scattering intensity across a range of angles, with an approximate maximum scattering intensity at a rainbow angle. The particular angle at which the maximum scattering intensity occurs depends on parameters such as the wavelength of light and the size of the water droplets. The calculation of the scattering intensity peak breadth and the background signal subtraction can be performed by a controller, such as controller 100.

Blue trend line 300 and infrared trend line 302 exhibit similar behavior from 100 degrees to 180 degrees. Blue trend line 300 and infrared trend line 302 generally increase from approximately 120 degrees to approximately 145 degrees, decrease from approximately 145 degrees to approximately 165 degrees, and increase from approximately 165 degrees to 180 degrees. The maximum scattering intensity along blue trend line 300 is approximately 0.0075, and the maximum scattering intensity along infrared trend line 302 is approximately 0.005. Blue trend line 300 has scattering intensity peak P_{blue} at approximately 144 degrees and scattering intensity peak breadth B_{blue}. Infrared trend line 302 has scattering intensity peak P_{IR} at approximately 143 degrees and scattering intensity peak breadth B_{IR}.

In FIG. 4B, blue trend line 304 depicts scattering intensities at 445 nm, and infrared trend line 306 depicts scattering intensities at 920 nm. In the same manner as blue trend line 300 and infrared trend line 302 described above in reference to FIG. 4A, blue trend line 304 and infrared trend line 306 exhibit similar behavior from 100 degrees to 180 degrees. Blue trend line 304 has scattering intensity peak P_{blue} at approximately 141 degrees and scattering intensity peak breadth B_{blue}. Infrared trend line 306 has scattering intensity peak P_{IR} at approximately 139 degrees and scattering intensity peak breadth B_{IR}.

In FIG. 4C, blue trend line 308 depicts scattering intensities at 445 nm, and infrared trend line 310 depicts scattering intensities at 920 nm. In the same manner as blue trend line 300 and infrared trend line 302 described above in reference to FIG. 4A, blue trend line 308 and infrared trend line 310 exhibit similar behavior from 100 degrees to 180 degrees. Blue trend line 308 has scattering intensity peak P_{blue} at approximately 140 degrees and scattering intensity peak breadth B_{blue}. Infrared trend line 310 has scattering intensity peak P_{IR} at approximately 137 degrees and scattering intensity peak breadth B_{IR}.

In FIG. 4D, blue trend line 312 depicts scattering intensities at 445 nm, and infrared trend line 314 depicts scattering intensities at 920 nm. In the same manner as blue trend line 300 and infrared trend line 302 described above in reference to FIG. 4A, blue trend line 312 and infrared trend line 314 exhibit similar behavior from 100 degrees to 180 degrees. Blue trend line 312 has scattering intensity peak P_{blue} at approximately 140 degrees and scattering intensity peak breadth B_{blue}. Infrared trend line 314 has scattering intensity peak P_{IR} at approximately 136 degrees and scattering intensity peak breadth B_{IR}.

The angle at which the scattering intensity peak occurs will generally decrease as the droplet size (as defined by MVD) increases. The scattering intensity peak breadth will generally decrease as the droplet size (as defined by MVD) increases. The angle of the scattering intensity peak and the breadth of the scattering intensity peak can be used to allow an OICS, such as OICS 10, to determine the representative droplet size present in a cloud such as cloud 14.

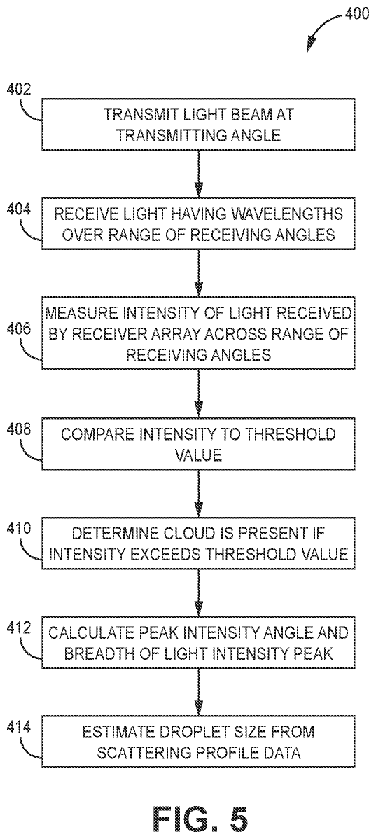

FIG. 5 depicts a method of operating an optical icing conditions sensor, such as OICS 10. Method 400 includes steps 402-414.

In step 402, a light beam is transmitted at a transmitting angle. This can be performed by, for example, a transmitter such as transmitter 16 described above in reference to FIG. 1. The light beam can have a wavelength, which in some examples can be 445 nm, and in other examples can be 920 nm.

In step 404, light having the wavelength is received over a range of receiving angles. This can be performed by, for example, a receiver array such as receiver array 18 described above in reference to FIG. 1. The receiver array can receive light from the transmitter, background light from other sources (such as the sun), or a combination of both.

In step 406, the intensity of light received by the receiver array in step 404 is measured. This can be performed by, for example, a controller such as controller 100 described above in reference to FIG. 2.

In step 408, the controller can compare the intensity of light measured in step 406 to a threshold value. The threshold value allows the controller to estimate if at least a portion of the light emitted by the transmitter was received by the receiver array. The threshold value can be selected based on the amount of light the transmitter emits. It should be understood that the threshold value should be selected to account for an expected amount of ambient background light from other sources. The threshold value can be manually selected (i.e., by a user) or automatically set by the controller or another component of the aircraft.

In step 410, the controller can determine whether a cloud is present. The controller can make this determination by assessing whether the intensity measured in step 406 exceeds the threshold value over the range of receiving angles. If the intensity exceeds the threshold value, the controller can determine that a cloud is present. The selection of the threshold value described above in step 408 thereby allows the controller to determine that, if the threshold value is exceeded, light from the transmitter has reflected off of a cloud and traveled to the receiver array.

In step 412, the controller can calculate scattering profile data based on the outcomes of steps 406-410 if a cloud is determined to be present in step 410. This scattering profile data can include quantities such as a scattering intensity peak angle and the breadth of the scattering intensity peak.

To generate the scattering profile data, the receiver array can receive light having the wavelength over the range of receiving angles and the controller can measure the intensity over the range of receiving angles. The range of receiving angles can include receiving angles which have been selected at discrete increments (for example, 1 degree intervals) or can include a continuous range of angles over which the controller measures scattering intensities. In this way, the controller can generate a scattering intensity profile such as those shown in FIGS. 4A-4D.

In some examples, more than one light beam having more than one wavelength can be used in steps 402-404 and 412 to generate scattering profile data. This can require multiple transmitters which are configured to emit light at the selected wavelengths, and can additionally require multiple threshold values as described in step 408. The use of more than one wavelength can increase the accuracy of droplet size estimations made with the controller.

In step 414, the controller can estimate the droplet size from the scattering profile data collected in step 412. The controller can make this droplet size estimation from, for example, a reference table containing expected scattering profile data for a range of droplet sizes.

The controller can additionally make other determinations about the type of cloud present through inputs from other aircraft components. For example, the controller can receive air temperature data from a temperature sensor. This data can allow the controller to determine whether a cloud contains supercooled liquid droplets. The controller can then communicate this determination to another aircraft component which can begin any required safety mechanisms, such as de-icing processes.

An optical sensor as described above provides numerous advantages. The estimation of droplet size within a cloud allows the tailoring of safety procedures based on expected icing conditions. The OICS described above allows for the use of low-cost lasers and photodetectors. Additionally, these components do not require extremely sensitive electronics, and low-speed digital electronics can be used to receive and measure input signal data.

### Discussion of Possible Embodiments

The following are non-exclusive descriptions of possible embodiments of the present invention.

An embodiment of a method of operating an optical icing conditions sensor for an aircraft includes transmitting, with a transmitter, a light beam having a wavelength through an optical window of the aircraft at a transmitting angle. The light beam illuminates an illumination volume. The transmitter is oriented along a transmitter path which extends along the transmitting angle. A receiver array receives light over a range of receiving angles relative to the transmitter path. The receiver array is configured to receive light having the wavelength over a receiver array field of view which overlaps with the illumination volume at a predetermined distance. A controller measures an intensity of light received by the receiver array. The controller compares the intensity to a threshold value. The controller determines that a cloud is present if the intensity is greater than the threshold value. The controller calculates scattering profile data of the light received by the receiver array if a cloud is determined to be present. The scattering profile data includes an angle of a scattering intensity peak within the range of receiving angles and a breadth of the scattering intensity peak. The controller estimates a representative droplet size within the cloud using the scattering profile data.

The method of the preceding paragraph can optionally include, additionally and/or alternatively, any one or more of the following features, configurations and/or additional components:

A method of operating an optical icing conditions sensor for an aircraft according to an exemplary embodiment of this disclosure, among other possible things includes transmitting, with a transmitter, a light beam having a wavelength through an optical window of the aircraft at a transmitting angle. The light beam illuminates an illumination volume. The transmitter is oriented along a transmitter path which extends along the transmitting angle. A receiver array receives light over a range of receiving angles relative to the transmitter path. The receiver array is configured to receive light having the wavelength over a receiver array field of view which overlaps with the illumination volume at a predetermined distance. A controller measures an intensity of light received by the receiver array. The controller compares the intensity to a threshold value. The controller determines that a cloud is present if the intensity is greater than the threshold value. The controller calculates scattering profile data of the light received by the receiver array if a cloud is determined to be present. The scattering profile data includes an angle of a scattering intensity peak within the range of receiving angles and a breadth of the scattering intensity peak. The controller estimates a representative droplet size within the cloud using the scattering profile data.

A further embodiment of the foregoing method, wherein the receiver array comprises a plurality of receivers. Each of the plurality of receivers has a receiver field of view. The receiver fields of view of the plurality of receivers define the receiver array field of view such that the receiver fields of view cover the range of receiving angles.

A further embodiment of any of the foregoing methods, further comprising communicating to a component of the aircraft, with the controller, the representative droplet size.

A further embodiment of any of the foregoing methods, further comprising measuring, with a temperature sensor, a cloud temperature of the cloud, and determining, with the controller, whether water droplets within the cloud are supercooled.

A further embodiment of any of the foregoing methods, wherein the representative droplet size is a median volumetric diameter.

A further embodiment of any of the foregoing methods, wherein the range of receiving angles is centered at approximately 136 degrees with respect to the transmitter path.

A further embodiment of any of the foregoing methods, wherein the range of receiving angles extends from approximately 126 degrees to approximately 146 degrees with respect to the transmitter path.

A further embodiment of any of the foregoing methods, wherein the wavelength is selected from the group consisting of 445 nanometers and 920 nanometers.

A further embodiment of any of the foregoing methods, further comprising communicating to a component of the aircraft, with the controller, the representative droplet size, measuring, with a temperature sensor, a cloud temperature of the cloud, and determining, with the controller, whether water droplets within the cloud are supercooled. The representative droplet size is a median volumetric diameter. The range of receiving angles is centered at approximately 136 degrees with respect to the transmitter path and extends from approximately 126 degrees to approximately 146 degrees with respect to the transmitter path. The wavelength is selected from the group consisting of 445 nanometers and 920 nanometers.

An embodiment of an optical icing conditions sensor for an aircraft includes a transmitter, a receiver array, and a controller. The transmitter is oriented along a transmitter path and is configured to transmit a light beam having a wavelength through an optical window at a transmitting angle relative to the optical window. The receiver array is configured to receive light having the wavelength over a range of receiving angles relative to the transmitter path. The controller is configured to measure an intensity of light received by the receiver array over the range of receiving angles. The controller is further configured to compare the intensity to a threshold value. The controller is further configured to determine that a cloud is present if the intensity is greater than the threshold value. The controller is further configured to calculate scattering profile data of the light received by the receiver array if a cloud is determined to be present. The scattering profile data includes an angle of a scattering intensity peak within the range of receiving angles and a breadth of the scattering intensity peak. The controller is further configured to estimate a representative droplet size within the cloud using the scattering profile data.

The optical icing conditions sensor of the preceding paragraph can optionally include, additionally and/or alternatively, any one or more of the following features, configurations and/or additional components:

An icing conditions optical icing conditions sensor for an aircraft according to an exemplary embodiment of this disclosure, among other possible things includes a transmitter, a receiver array, and a controller. The transmitter is oriented along a transmitter path and is configured to transmit a light beam having a wavelength through an optical window at a transmitting angle relative to the optical window. The receiver array is configured to receive light having the wavelength over a range of receiving angles relative to the transmitter path. The controller is configured to measure an intensity of light received by the receiver array over the range of receiving angles. The controller is further configured to compare the intensity to a threshold value. The controller is further configured to determine that a cloud is present if the intensity is greater than the threshold value. The controller is further configured to calculate scattering profile data of the light received by the receiver array if a cloud is determined to be present. The scattering profile data includes an angle of a scattering intensity peak within the range of receiving angles and a breadth of the scattering intensity peak. The controller is further configured to estimate a representative droplet size within the cloud using the scattering profile data.

A further embodiment of the foregoing optical icing conditions sensor, wherein the controller is further configured to communicate the representative droplet size to a component of the aircraft.

A further embodiment of any of the foregoing optical icing conditions sensors, further comprising a temperature sensor which is configured to measure cloud temperature. The controller is configured to determine whether water droplets within the cloud are supercooled.

A further embodiment of any of the foregoing optical icing conditions sensors, wherein the wavelength is selected from the group consisting of 445 nanometers and 920 nanometers.

A further embodiment of any of the foregoing optical icing conditions sensors, further comprising a temperature sensor which is configured to measure cloud temperature. The controller is configured to communicate the representative droplet size to a component of the aircraft. The controller is configured to determine whether water droplets within the cloud are supercooled. The representative droplet size is a median volumetric diameter. The range of receiving angles is centered at approximately 136 degrees with respect to the transmitter path and extends from approximately 126 degrees to approximately 146 degrees with respect to the transmitter path. The wavelength is selected from the group consisting of 445 nanometers and 920 nanometers.

An embodiment of a controller for an optical icing conditions sensor of an aircraft includes at least one processor, at least one memory unit, and at least one communication unit. The controller is configured to measure an intensity of light received by a receiver array over a range of receiving angles. The controller is further configured to compare the intensity to a threshold value. The controller is further configured to determine that a cloud is present if the intensity is greater than the threshold value. The controller is further configured to calculate scattering profile data of the light received by the receiver array if a cloud is determined to be present. The scattering profile data includes an angle of a scattering intensity peak within the range of receiving angles and a breadth of the scattering intensity peak. The controller is further configured to estimate a representative droplet size within the cloud using the scattering profile data.

The controller of the preceding paragraph can optionally include, additionally and/or alternatively, any one or more of the following features, configurations and/or additional components:

A controller for an optical icing conditions sensor of an aircraft according to an exemplary embodiment of this disclosure, among other possible things includes at least one processor, at least one memory unit, and at least one communication unit. The controller is configured to measure an intensity of light received by a receiver array over a range of receiving angles. The controller is further configured to compare the intensity to a threshold value. The controller is further configured to determine that a cloud is present if the intensity is greater than the threshold value. The controller is further configured to calculate scattering profile data of the light received by the receiver array if a cloud is determined to be present. The scattering profile data includes an angle of a scattering intensity peak within the range of receiving angles and a breadth of the scattering intensity peak. The controller is further configured to estimate a representative droplet size within the cloud using the scattering profile data.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of operating an optical icing conditions sensor for an aircraft, the method comprising:
transmitting, with a transmitter, a light beam having a wavelength through an optical window of the aircraft at a transmitting angle, wherein the light beam illuminates an illumination volume and the transmitter is oriented along a transmitter path which extends along the transmitting angle;
receiving, with a receiver array, light over a range of receiving angles relative to the transmitter path, wherein the receiver array is configured to receive light having the wavelength over a receiver array field of view, and the receiver array field of view overlaps with the illumination volume at a predetermined distance;
measuring, with a controller, an intensity of light received by the receiver array;
comparing, with the controller, the intensity to a threshold value;
determining, with the controller, that a cloud is present if the intensity is greater than the threshold value;
calculating, with the controller, scattering profile data of the light received by the receiver array if a cloud is determined to be present, wherein the scattering profile data includes an angle of a scattering intensity peak within the range of receiving angles and a breadth of the scattering intensity peak; and
estimating, with the controller, a representative droplet size within the cloud using the scattering profile data.

2. The method of claim 1, wherein:
the receiver array comprises a plurality of receivers;
each of the plurality of receivers has a receiver field of view; and
the receiver fields of view of the plurality of receivers define the receiver array field of view such that the receiver fields of view cover the range of receiving angles.

3. The method of claim 1, further comprising communicating to a component of the aircraft, with the controller, the representative droplet size.

4. The method of claim 1, further comprising:
measuring, with a temperature sensor, a cloud temperature of the cloud; and
determining, with the controller, whether water droplets within the cloud are supercooled.

5. The method of claim 1, wherein the representative droplet size is a median volumetric diameter.

6. The method of claim 1, wherein the range of receiving angles is centered at approximately 136 degrees with respect to the transmitter path.

7. The method of claim 6, wherein the range of receiving angles extends from approximately 126 degrees to approximately 146 degrees with respect to the transmitter path.

8. The method of claim 1, wherein the wavelength is selected from the group consisting of 445 nanometers and 920 nanometers.

9. The method of claim 1, further comprising:
communicating to a component of the aircraft, with the controller, the representative droplet size;
measuring, with a temperature sensor, a cloud temperature of the cloud; and
determining, with the controller, whether water droplets within the cloud are supercooled;
wherein:
the representative droplet size is a median volumetric diameter;
the range of receiving angles is centered at approximately 136 degrees with respect to the transmitter path and extends from approximately 126 degrees to approximately 146 degrees with respect to the transmitter path; and
the wavelength is selected from the group consisting of 445 nanometers and 920 nanometers.

10. An optical icing conditions sensor for an aircraft, the optical icing conditions sensor comprising:
a transmitter oriented along a transmitter path, wherein the transmitter is configured to transmit a light beam having a wavelength through an optical window at a transmitting angle relative to the optical window;
a receiver array configured to receive light having the wavelength over a range of receiving angles relative to the transmitter path; and
a controller, wherein the controller is configured to:
measure an intensity of light received by the receiver array over the range of receiving angles;
compare the intensity to a threshold value;
determine that a cloud is present if the intensity is greater than the threshold value;
calculate scattering profile data of the light received by the receiver array if a cloud is determined to be present, wherein the scattering profile data includes an angle of a scattering intensity peak within the range of receiving angles and a breadth of the scattering intensity peak; and
estimate a representative droplet size within the cloud using the scattering profile data.

11. The optical icing conditions sensor of claim 10, wherein the controller is further configured to communicate the representative droplet size to a component of the aircraft.

12. The optical icing conditions sensor of claim 10, further comprising a temperature sensor which is configured to measure cloud temperature, and wherein the controller is configured to determine whether water droplets within the cloud are supercooled.

13. The optical icing conditions sensor of claim 10, wherein the wavelength is selected from the group consisting of 445 nanometers and 920 nanometers.

14. The optical icing conditions sensor of claim 10, further comprising:
a temperature sensor which is configured to measure cloud temperature;
wherein:
the controller is configured to communicate the representative droplet size to a component of the aircraft;
the controller is configured to determine whether water droplets within the cloud are supercooled;
the representative droplet size is a median volumetric diameter;
the range of receiving angles is centered at approximately 136 degrees with respect to the transmitter path and extends from approximately 126 degrees to approximately 146 degrees with respect to the transmitter path; and
the wavelength is selected from the group consisting of 445 nanometers and 920 nanometers.

15. A controller for an optical icing conditions sensor of an aircraft, the controller comprising:
at least one processor;
at least one memory unit; and
at least one communication unit;
wherein the controller is configured to:
measure an intensity of light received by a receiver array over a range of receiving angles;
compare the intensity to a threshold value;
determine that a cloud is present if the intensity is greater than the threshold value;
calculate scattering profile data of the light received by the receiver array if a cloud is determined to be present, wherein the scattering profile data includes an angle of a scattering intensity peak within the range of receiving angles and a breadth of the scattering intensity peak; and
estimate a representative droplet size within the cloud using the scattering profile data.
